(19) United States
(12) Patent Application Publication
(10) Pub. No.: US 2018/0170341 A1
(43) Pub. Date: Jun. 21, 2018

(54) REMOVABLE COVER FOR BRAKE FLUID RESERVOIRS IN MOTORCYCLES

(71) Applicant: Jason Romines, Cathedral City, CA (US)

(72) Inventor: Jason Romines, Cathedral City, CA (US)

(21) Appl. No.: 15/844,443

(22) Filed: Dec. 15, 2017

Related U.S. Application Data
(60) Provisional application No. 62/434,872, filed on Dec. 15, 2016.

(51) Int. Cl. B60T 17/22; B60T 11/26; B60T 17/06

(52) U.S. Cl. CPC B60T 17/225; B60Y 2200/12; B60T 17/06; B60T 11/26

(57) ABSTRACT

A removable cover is an apparatus that is used to externally protect a brake fluid reservoir of a motorcycle. The apparatus includes a membrane. The membrane is used to enclose the exterior surface of a brake fluid reservoir. The membrane includes at least one opening, and an external surface. The at least one opening allows the apparatus to receive a brake fluid reservoir. The external surface is preferably configured to form a head including eyes, nose, and ears. The membrane is capable of forming a volume configured to enclose a brake fluid reservoir. At least a portion of the membrane possess elasticity allowing the apparatus to fit on any size brake fluid reservoir.

The current application claims a priority to the U.S. Provisional Patent application Ser. No. 62/434,872 filed on Dec. 15, 2016.

### FIELD OF THE INVENTION

The present disclosure generally relates to the field of automobiles. More specifically, the present disclosure relates to a removable cover for brake fluid reservoirs for motorcycles.

### BACKGROUND OF THE INVENTION

Motorcycles include a brake fluid reservoir that is generally located above the front brake lever. The brake fluid reservoir contains brake fluid, that is used hen brakes are applied.

It is a general recommendation to cover brake fluid reservoirs with the help of a brake fluid reservoir cover or “sock” as it aids in protecting the exterior of the brake fluid reservoir, and the brake fluid itself to avoid direct sunlight.

Further, brake fluid reservoir “socks” also help prevent leaks during the operation of motorcycles, and protect the paint of the motorcycle from being damaged by hot brake fluid during operation, and protects the rider from an accidental spray across the visor of the helmet that may impair the vision.

However, present brake fluid reservoir covers or “socks” have limited visual appeal, and are not aesthetically pleasing. Further, these “socks” are generally of similar physical dimensions and do not have many variations.

In addition, present brake fluid reservoir covers, do not have any means to allow the users to view the level of brake fluid inside the brake fluid reservoirs, nor is the level of fluid transmitted or displayed on an external device.

Further, present covers do not allow any access to the brake fluid reservoir once they have been installed in place. Therefore, users may have to take the removable covers off when they may need to refill the brake fluid reservoir.

Further, present covers do not have any additional features and do not contain in-built cameras that may record and take pictures. Additionally, present covers are susceptible to being stolen, as they may be easily removed, and do not contain any GPS mechanism to display where the removable cover and therefore the motorcycle may be located.

Further, current systems do not allow any customization to implemented and are static in their appearance. Further, present covers do not allow any external information or any preset patterns, or colors to be displayed on them.

Therefore, there is a need for an improved brake fluid reservoir cover that may overcome one or more of the above-mentioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some embodiments, a removable cover for a brake fluid reservoir is disclosed. The removable cover may essentially be an elastic membrane configured to enclose the exterior surface of a cylinder. The membrane may have an external surface and an opening that may allow access to the formed volume so that the brake fluid reservoir may be enclosed in the volume formed by the membrane.

The external surface of the membrane may be formed in various shapes to increase the aesthetic appeal of the removable cover. The external surface may be modeled to any shape to increase the aesthetic appeal of the removable cover.

The removable cover may allow the protection of vital parts of a motorcycle from leaking hot brake fluid while the motorcycle may be stationary, or running. Further, the removable cover may protect the user from any accidental spray of leaking hot brake fluid when the motorcycle may be running. Further, the removable cover may also have an increased aesthetic appeal to the user, and or any other viewers.

Further, the removable cover may include a side pouch incorporated into the structure that may be used to store objects that may be consistent with the dimensions, and volume of the pouch.

Further, the removable cover may include a flexible OLED. The flexible OLED may be programmable and may be able to display any pattern, textures, colors, and any information. In some embodiments, the programmable information may include a level of brake fluid in the brake fluid reservoir. The flexible OLED may be inherently transparent, or translucent. The user may be able to view the brake fluid reservoir when no content may be displayed on the flexible OLED.

Therefore, the user may be able to view the level of brake fluid in the brake fluid reservoir even with the removable cover installed.

Further, the removable cover may have a camera embedded in it. The camera may be used to capture a dash view of the rider while riding the motorcycle. Alternately, the camera may face towards the movement of the motorcycle and may be used to capture the road from the steering perspective.

In further embodiments, the removable cover may also be used to cover alternate exposed components of an automobile. For instance, the removable cover may be installed on the gear shift lever of a car.

Further, the removable cover may also include GPS sensor. The GPS sensor may constantly broadcast the location of the removable cover, and therefore the motorcycle, and may increase the security of the motorcycle, and also the removable cover.

Further, the removable cover may have a part of the body transparent to view the contents of the brake fluid reservoir, so that the level of fluid in the brake fluid reservoir may be visible at all times.

Further, the removable sensor may also include a level sensor to gauge and display or transmit the level of brake fluid in the brake fluid reservoir. The cover may also include a temperature sensor to gauge and transmit the temperature of brake fluid in the brake fluid reservoir.

Further, the removable cover may also include an opening to allow the user access to the filling orifice of the brake fluid reservoir and refill the brake fluid reservoir with brake fluid.

Further, the removable may also be customizable by having multiple removable connected components. The removable components may be of various shapes, sizes, and colors to enhance the visual appeal of the removable cover.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a perspective view of a brake fluid reservoir cover 100 consistent with various embodiments of the present disclosure.

FIG. 2 is an illustration of a perspective front view of a brake fluid reservoir cover 100 consistent with various embodiments of the present disclosure.

FIG. 3 is an illustration of a perspective back view of a brake fluid reservoir cover 100 consistent with various embodiments of the present disclosure.

FIG. 4 is an illustration of a perspective left side view of a brake fluid reservoir cover 100 consistent with various embodiments of the present disclosure.

FIG. 5 is an illustration of a perspective right side view of a brake fluid reservoir cover 100 consistent with various embodiments of the present disclosure.

FIG. 6 is an illustration of a perspective top view of a brake fluid reservoir cover 100 consistent with various embodiments of the present disclosure.

FIG. 7 is an illustration of a perspective bottom view of a brake fluid reservoir cover 100 consistent with various embodiments of the present disclosure.

FIG. 8 is an illustration of a brake fluid reservoir cover installed on a brake fluid reservoir 802 consistent with various embodiments of the present disclosure.

FIG. 9 is an illustration of an additional embodiment of a brake fluid reservoir cover, with a part of the body transparent to view the contents of the brake fluid reservoir, consistent with various embodiments of the present disclosure.

FIG. 10 is an illustration of an additional embodiment of a brake fluid reservoir cover that has a level sensor incorporated to transmit the level of brake fluid in the brake fluid reservoir, consistent with various embodiments of the present disclosure.

FIG. 11 is an illustration of an additional embodiment of a brake fluid reservoir cover that has an opening and a flap incorporated to access the filling orifice the brake fluid reservoir, consistent with various embodiments of the present disclosure.

FIG. 12 is an illustration of an additional embodiment of a brake fluid reservoir cover that includes a common receiving base that may receive multiple upper elongations, consistent with various embodiments of the present disclosure.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of automobiles and a removable cover for brake fluid reservoirs for motorcycles, embodiments of the present disclosure are not limited to use only in this context.

A removable cover for the brake fluid reservoir of a motorcycle may essentially be an elastic membrane configured to enclose the exterior surface of a cylinder. The membrane may have an external surface and an opening that may allow access to the formed volume so that the brake fluid reservoir may be enclosed in the volume formed by the membrane.

The membrane may have an internal surface. The internal surface may enclose the cylindrical profile of the brake fluid reservoir. The membrane may be able to encase cylinders of multiple volumes by the virtue of the elasticity of the material that comprises it. The membrane may be formed to have a substantially complementary shape to that of the part of the cylinder with which it is held in contact with. The surfaces may also provide a tensioning to the brake fluid reservoir. Therefore, the inner surface may be significantly lesser in dimensions in comparison to the outer surface.

The external surface of the membrane may be formed in various shapes to increase the aesthetic appeal of the removable cover. In the preferred embodiment, the external surface may be formed to resemble the shape of a head and face. The head may include an eye, a nose, a mouth, an ear, or a combination of any of these. Alternately, the external surface may be modeled to any shape to increase the aesthetic appeal of the removable cover. For instance, the removable cover may be in the shape of a popular character, or any other object that the user may prefer.

In further embodiments, the membrane may be made up of any particular material to incorporate the physical and chemical of the material properties in the removable cover. If the material of the membrane does not have elastic properties, the removable cover may also have a fastening mechanism to fasten the removable cover to the brake fluid reservoir. The fastening mechanism may be fitted to the opening of the removable cover and may be made in the form of an elastic band, a stretchable string that may emerge from two adjacent pierced openings in the material, a clip fastener, a Velcro fastener, a releasable-glue fastener, or any other suitable means. The fastening mechanism may be adapted to be engaged on the cylindrical profile of the brake fluid reservoir.

The removable cover is also formed to have outer and inner surfaces that may be formed to have a substantially complementary shape to that of the part of the brake fluid reservoir with which it is held in contact with the fastening means. The surfaces may also provide a tensioning to the brake fluid reservoir. Therefore, the inner surface may be significantly lesser in dimensions in comparison to the outer surface.

The removable cover may allow the protection of vital parts of a motorcycle from leaking hot brake fluid while the motorcycle may be stationary, or running. Further, the removable cover may protect the user from any accidental spray of leaking hot brake fluid when the motorcycle may be running. Further, the removable cover may also have an increased aesthetic appeal to the user, and or any other viewers.

Further, the removable cover may have different means to fasten around the brake fluid reservoir. In some embodiments, the removable cover may be made from an elastic material, and may not need any additional fastening means. In other embodiments, the removable cover may be made of other material to encapsulate the chemical and physical properties of the material used while manufacturing the removable covers and may need additional fastening means, like an elastic band, or a string tightening mechanism. These additional mechanisms may allow the removable cover to be better secured to the brake fluid reservoir.

In further embodiments, the removable cover may include a side pouch incorporated into the structure. The pouch may be connected to the main body through means of stitching, or any other suitable manner, and may be used to store objects that may be consistent with the dimensions, and volume of the pouch. Further, the pouch may not be connected externally to the removable cover and may exist as a pocket that may have been stitched in the seams of the membrane material to allow the pouch to be hidden from plain sight and add a level of secrecy and, therefore, an additional level of safety while objects may be stored in the pouch.

In further embodiments, the removable cover may include a flexible OLED. The flexible OLED may be programmable and may be able to display any pattern, textures, colors, and any information. Accordingly, the flexible OLED may have a power source (e.g. battery) to power the flexible OLED. Further, the flexible OLED may also have a processor that may control the flexible OLED and regulate the patterns, and other information that may be displayed on the flexible OLED. The processor may be coupled with a receiver configured to receive instructions from an external device (like a smartphone), that may control the content to be displayed on the display. Further, the flexible OLED may also have a memory that may contain a set of patterns that may be displayed on the flexible OLED. For example, the information stored in the memory may be the logos of a competition, a specific team, or any other color pattern that the user may want to display on the flexible OLED and change the appearance of the removable cover.

In some embodiments, the flexible OLED may be configured to display the level of brake fluid in the brake fluid reservoir. Accordingly, the processor may be coupled to a level sensor configured to detect the level of brake fluid in the brake fluid reservoir.

Further, the flexible OLED may also be used to display any information that may be required by the user. For example, the user may choose to view a map or a navigation route that he may be traveling on. Therefore, the brake fluid reservoir cover may have a completely customizable exterior appearance. Further, the flexible OLED may be inherently transparent, or translucent. The user may be able to view the brake fluid reservoir when no content may be displayed on the flexible OLED and may control the transparency of the display by a touch interface on the flexible OLED, a button, or even an external device like a smartphone. Therefore, the user may be able to view the level of brake fluid in the brake fluid reservoir even with the removable cover installed.

In further embodiments, the removable cover may have a camera embedded in it. The location of the camera may vary based on the physical construction of the removable cover. For instance, if the removable cover is in the shape of an animal head, a camera may be located in the eye. The camera may be used to capture a dash view of the rider while riding the motorcycle. Alternately, the camera may face towards the movement of the motorcycle and may be used to capture the road from the steering perspective. Accordingly, the camera may also have a microprocessor to control the functions of the camera such as to begin or stop recording, capture images and to transmit the images captured to any suitable device. The camera may also have a memory storage to store the pictures, and videos captured by the camera. Further, the camera may also be an infrared and night vision camera. Therefore, the camera may continue recording, and taking pictures even if the ambient light is not adequate during low light, and night conditions.

In further embodiments, the removable cover may also be used to cover alternate exposed components of an automobile. For instance, the removable cover may be installed on the gear shift lever of a car. The removable cover may hence increase the visual appeal of the gear shift, and may also increase the grip by providing and an anti-slip texture.

In further embodiments, the removable cover may also include GPS sensor. The GPS sensor may constantly broadcast the location of the removable cover, and therefore the motorcycle, and may increase the security of the motorcycle, and also the removable cover. The removable cover may also be used to track the location of the user's motorcycle in case it is stolen. The location of the GPS sensor may be viewed by an external device like a smartphone. Accordingly, the GPS sensor may also include a transmitter to broadcast the location to an external device over a communication network. Further, the GPS sensor may also be used for navigation and may help the user navigate unknown routes. Accordingly, the removable cover may also include a display to display the location and navigation route based on the GPS sensor.

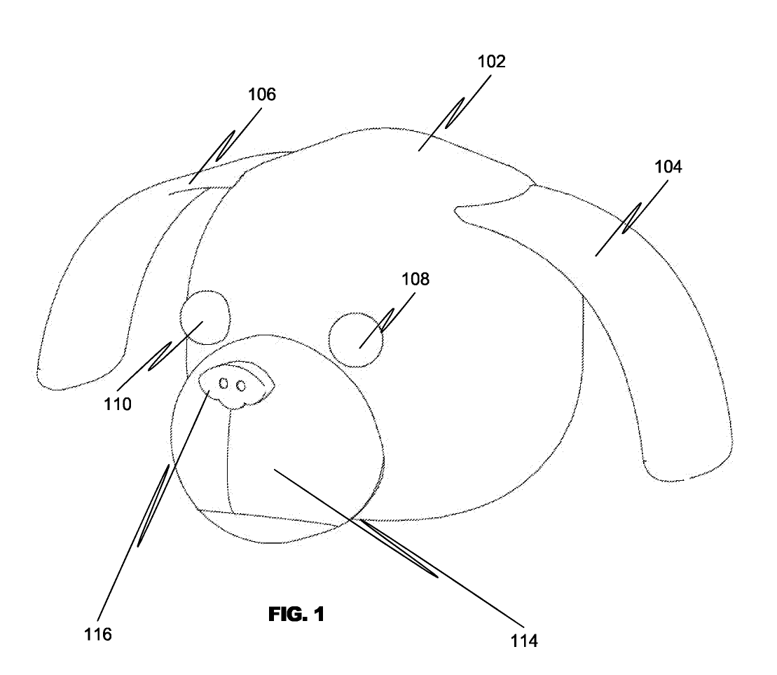

FIG. 1 shows a preferred embodiment of a brake fluid reservoir cover 100 in the shape of a dog head. The cover may be of any color or color design matching the shape and design of the removable cover. For example, if the removable cover is in the shape and design of a panda bear it may include a black and white coloring theme. The main body of the removable cover may be composed of leather. In another embodiment, the main body may be composed of alternate materials, like cotton, or polyester, or plastics. The cover may also comprise a variety of design components based on the shape design of the removable cover. In the displayed exemplary embodiment, the main body 102 comprises a left ear piece 104, a right ear piece 106, a left eyeball piece 108, a right eyeball piece 110 and front face protrusion 114. The left ear 104 piece extends from the top left of the main body 102. The right ear piece 106 extends from the top right of the main body 102. The front protrusion 114 extends from the lower front of the main body 102. The left eyeball piece 108 is positioned above the front protrusion 114 and towards the left side of the main body 102. The right eyeball piece 110 is positioned above the front protrusion 114 and towards the right side of the main body 102. The left eyeball piece 108 and the right eyeball piece 110 may be any shape and size and may be composed of any suitable material. The left eyeball piece 108 and the right eyeball piece 110 are fixed to the main body 102. The left ear piece 104 and right ear piece 106 are also fixed to the main body 102. The front protrusion 114 further comprises a nosepiece 116 positioned near the top of the front protrusion 114 and a mouth design.

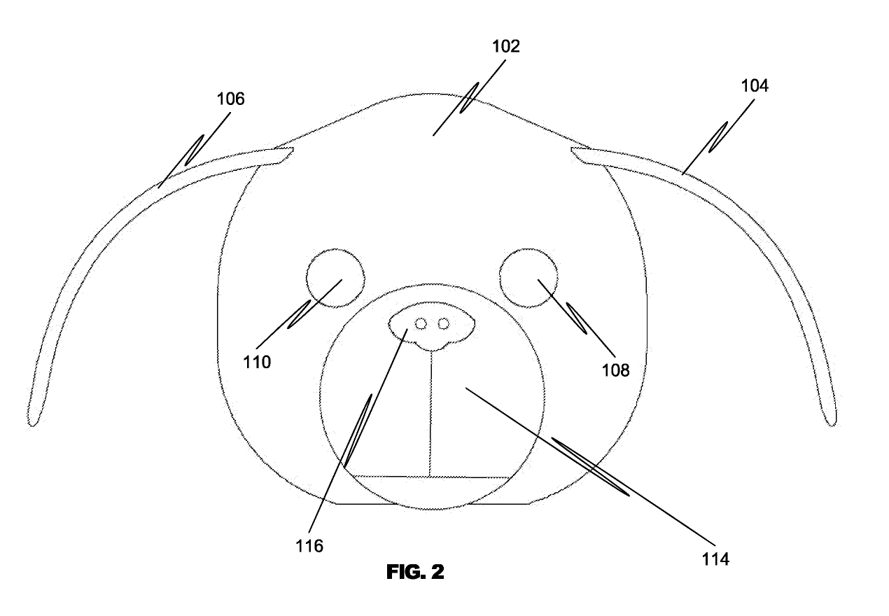

FIG. 2 is an illustration of a perspective front view of a brake fluid reservoir cover 100 consistent with various embodiments of the present disclosure.

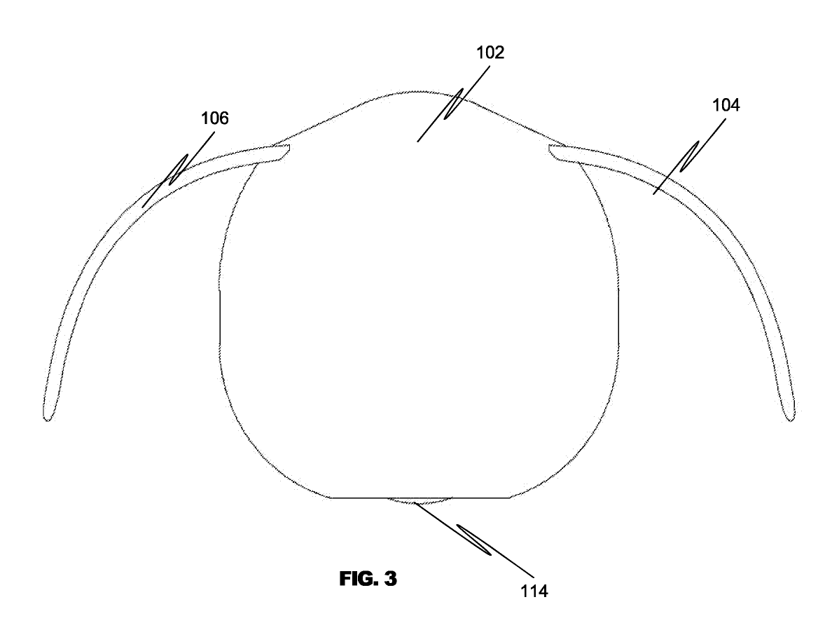

FIG. 3 is an illustration of a perspective back view of a brake fluid reservoir cover 100 consistent with various embodiments of the present disclosure.

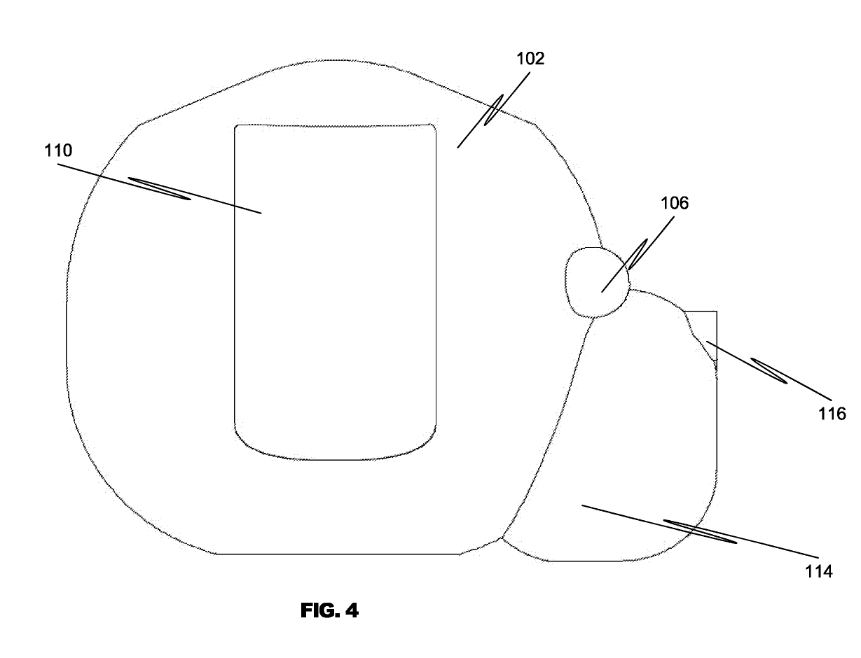

FIG. 4 is an illustration of a perspective left side view of a brake fluid reservoir cover 100 consistent with various embodiments of the present disclosure.

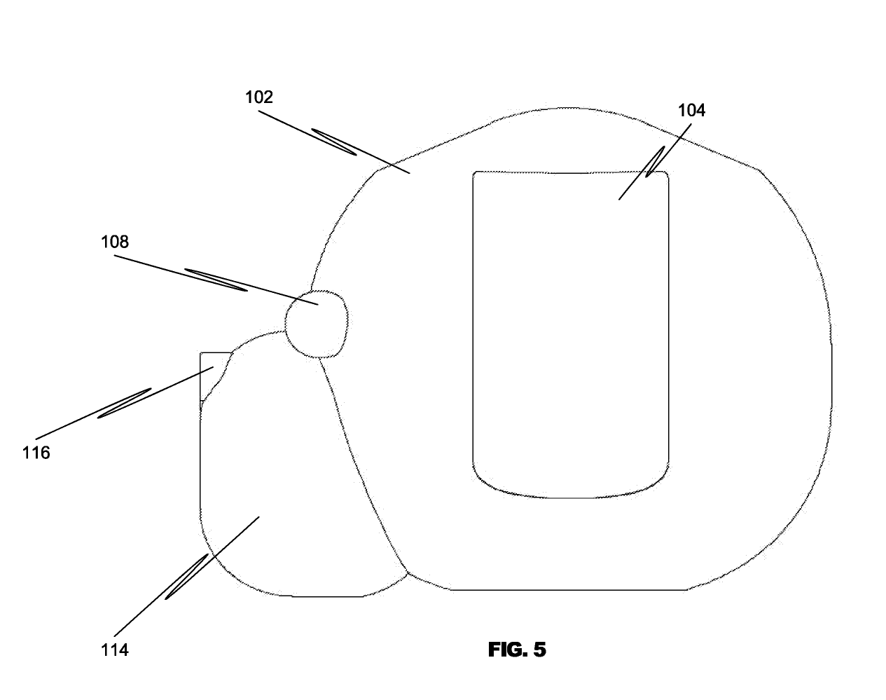

FIG. 5 is an illustration of a perspective right side view of a brake fluid reservoir cover 100 consistent with various embodiments of the present disclosure.

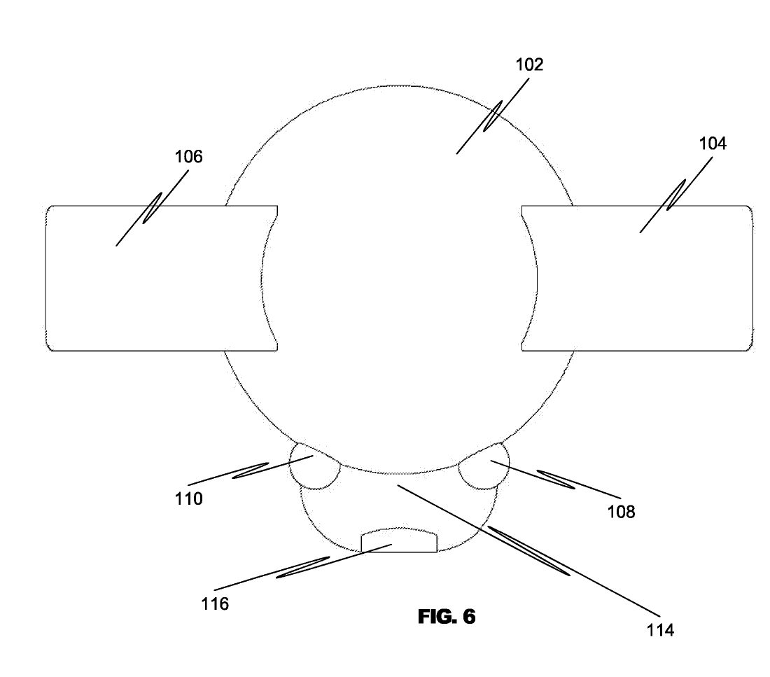

FIG. 6 is an illustration of a perspective top view of a brake fluid reservoir cover 100 consistent with various embodiments of the present disclosure.

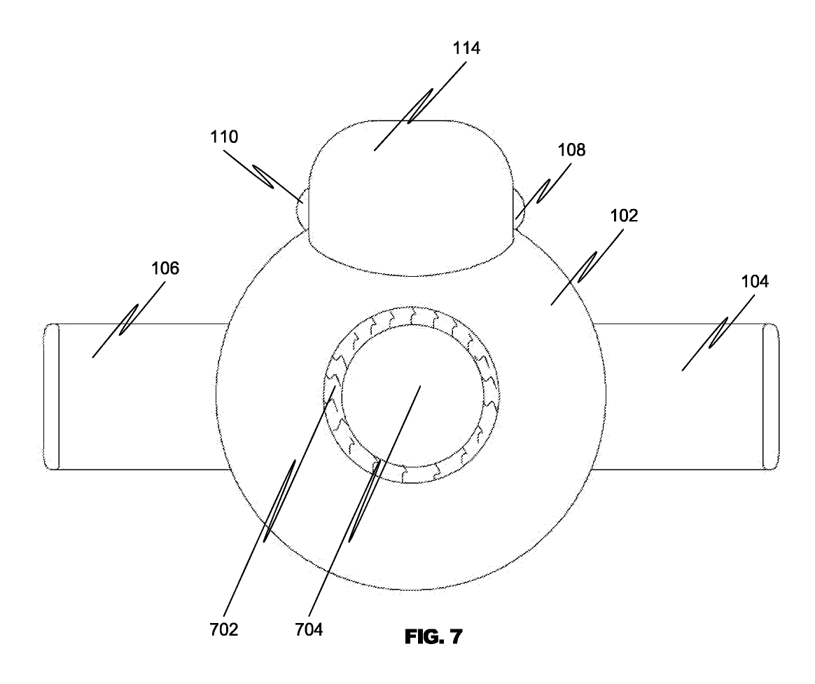

FIG. 7 is an illustration of a perspective bottom view of a brake fluid reservoir cover 100 consistent with various embodiments of the present disclosure. An opening 704 is positioned at the bottom center of the main body 102. The opening may allow the brake fluid reservoir access to the volume formed inside the main body 102. The opening 704 may vary in size and shape and may depend on the size of the brake fluid reservoir that it may be used to cover. For example, the opening may be of a greater size if the brake fluid reservoir to be covered is larger in diameter. An elastic band, that acts as a fastening mechanism 702 may be positioned inside the main body along the circumference of the opening. The elastic band may allow the opening to be stretched over a fluid reservoir of a motorcycle and firmly grasp the fluid reservoir. In other embodiments, the elastic band may be replaced by a string or any other appropriate fastening mechanism. In some embodiments, a separate fastening mechanism may be redundant, as the removable cover may grasp the brake fluid reservoir by the property of the material with which it has been constructed. For example, if the brake fluid reservoir cover is made out of rubber, or any other elastic material, the removable cover may not need any additional fastening mechanism at the opening 704.

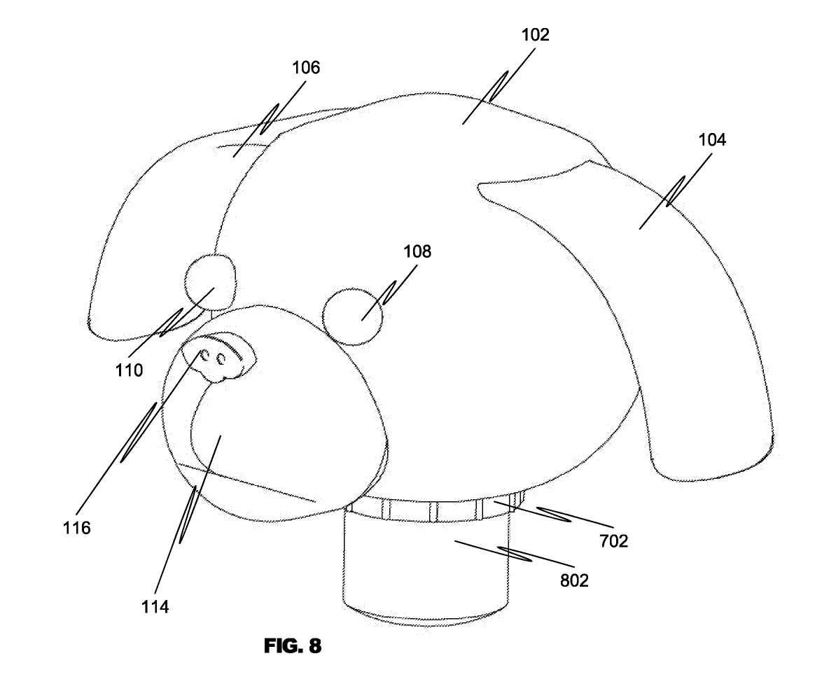

FIG. 8 is an illustration of a brake fluid reservoir cover installed on a brake fluid reservoir 802 consistent with various embodiments of the present disclosure.

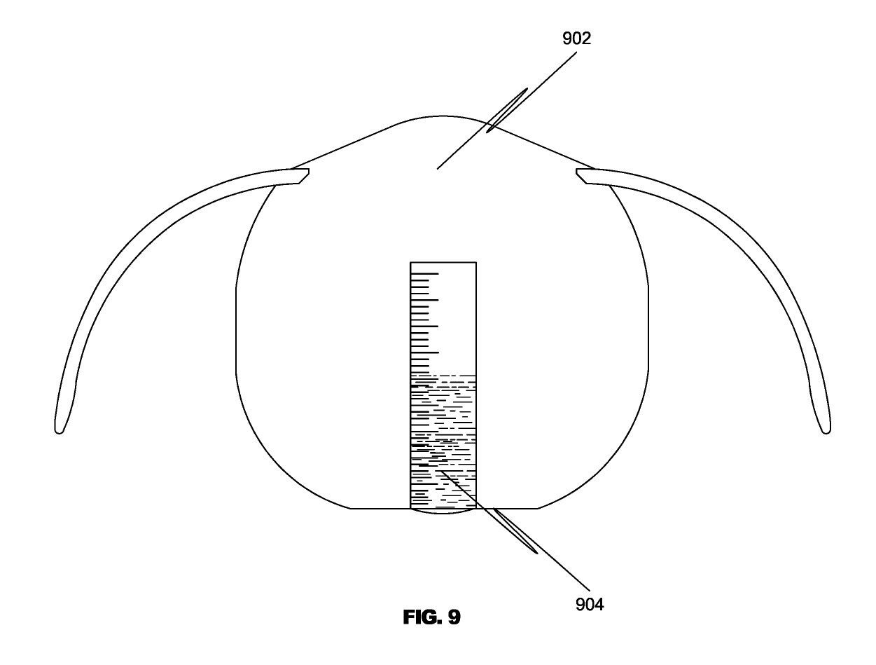

FIG. 9 shows an additional embodiment of the removable cover 902, with a part of the body 904 transparent to view the contents of the brake fluid reservoir, consistent with various embodiments of the present disclosure. If the removable cover is used as intended in the preferred embodiment illustrated in FIGS. 1-8, it may entirely shroud the brake fluid reservoir. Hence, it may be difficult, or even impossible to discern the level of brake fluid that may be present in the brake fluid reservoir. Therefore, in some embodiments, the removable cover and membrane may include a transparent, or translucent material 904, so that the level of fluid in the brake fluid reservoir may be visible at all times. The transparent or translucent material may form the base of the removable cover or may extend only over a significantly smaller area of the removable cover along the length of the cylindrical reservoir, therefore allowing the user to view the level of brake fluid inside the brake fluid reservoir. The user may then refill the brake fluid reservoir with the appropriate amount of brake fluid. In other embodiments, the transparent cross-section may differ in shape, and therefore the area of the brake fluid reservoir that may be visible to the user. The transparent cross-section may also include an opaque scale to view the exact volume of brake fluid present inside the brake fluid reservoir accurately.

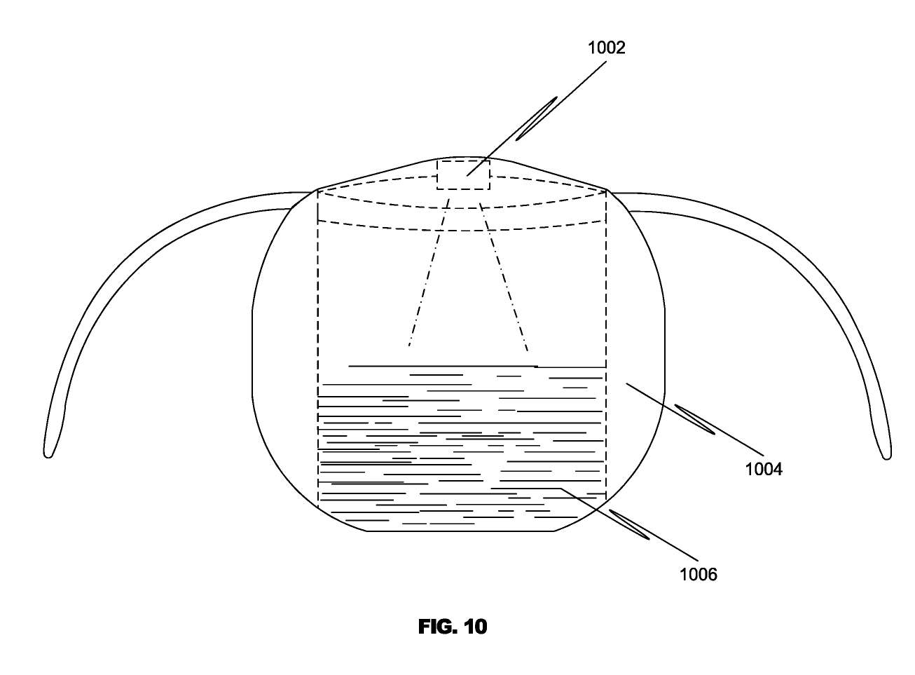

FIG. 10 shows an additional embodiment of the removable cover 1004 that includes a non-contact ultrasonic sensor 1002 to gauge the level of fluid in the brake fluid reservoir 1006. The sensor 1002 may consist of an analog signal processor, a microprocessor, binary coded decimal i.e. BCD range switches, and an output driver circuit. The microprocessor may generate the gate signal and pulses and may direct them to the ultrasonic sensor through the analog signal processor. The sensor 1002 may then transmit a beam of ultrasonic waves to the surface of the fluid, and receive the reflected echoes from the fluid surface. The sensor 1002 may send the signal received from the reflected echoes back to the microprocessor, which may then determine the distance between the sensor and the fluid surface to detect the fluid level. Alternatively, the sensor may be a differential pressure sensor that may measure the level of fluid by measuring the difference in pressure exerted by the fluid at various volumes. Further, the differential pressure sensor may also have a microprocessor that may compute the level of fluid based on the amount of fluid that may be present in the brake fluid reservoir and may transmit the information to an external device like the smartphone, or the smartwatch of a user through a smartphone. The transmitter may transmit the level of fluid when reduces beyond a predefined level, transmit the level of fuel constantly, or may do so at any predefined time. In other embodiments, any suitable sensor may be incorporated into the removable cover that may detect the level and volume of brake fluid in the brake fluid reservoir, and transmit the information to a suitable external device. The external device may the smartphone, or smartwatch of the user. Alternatively, the removable cover may also include a small display to display the level of fluid in the brake fluid reservoir.

Further, the sensor may be a temperature sensor that may continuously monitor the temperature of the brake fluid. The temperature sensor may include a processor to monitor the temperature, and send alerts to an external device, and a memory to store the temperature values of the brake fluid in the brake fluid reservoir. Brake fluids are hygroscopic and may absorb and retain water in the form of moisture. Therefore, the boiling point of the brake fluid may reduce significantly, that may lead to a malfunction of brakes. Therefore, the temperature sensor may alert the user if the temperature of the brake fluid rises above any predetermined level. The temperature after which the sensor may send an alert message to the user may be pre-defined. The sensor may alert the user by sending a notification to the smartphone, or any smart device of the user. Alternatively, the sensor may also make use of a display incorporated into the removable cover.

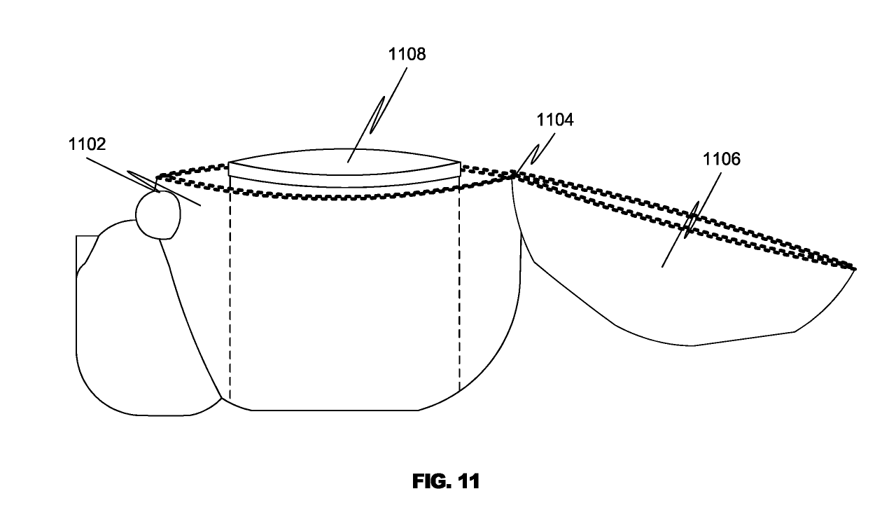

FIG. 11 shows an additional embodiment of the removable cover 1102 that includes an opening to allow the user access to the filling orifice 1108 of the brake fluid reservoir and refill the brake fluid reservoir with brake fluid. Accordingly, the removable cover may contain an openable flap 1106. The flap 1106 may be made in a shape that is consistent with the aesthetic look of the removable cover, may be opened to reveal the filling orifice of the brake fluid reservoir 1108, and may be used to fill the brake fluid reservoir with the required amount of brake fluid. The flap 1106 may give access to an opening that may be generally closed, to maintain the visual appeal of the removable cover. The opening may be only accessed when needed to refill the brake fluid reservoir. The opening may be shut closed by the means of a zipper, Velcro, or another suitable fastening mechanism 1104 that may fasten the flap 1106 with the removable cover 1102. Alternately, the flap may be held in place and may be opened with the help of a snap-fastener, in which circular lip under one disc may fit into a groove on the top of another disc, holding them together until a certain amount of force is applied.

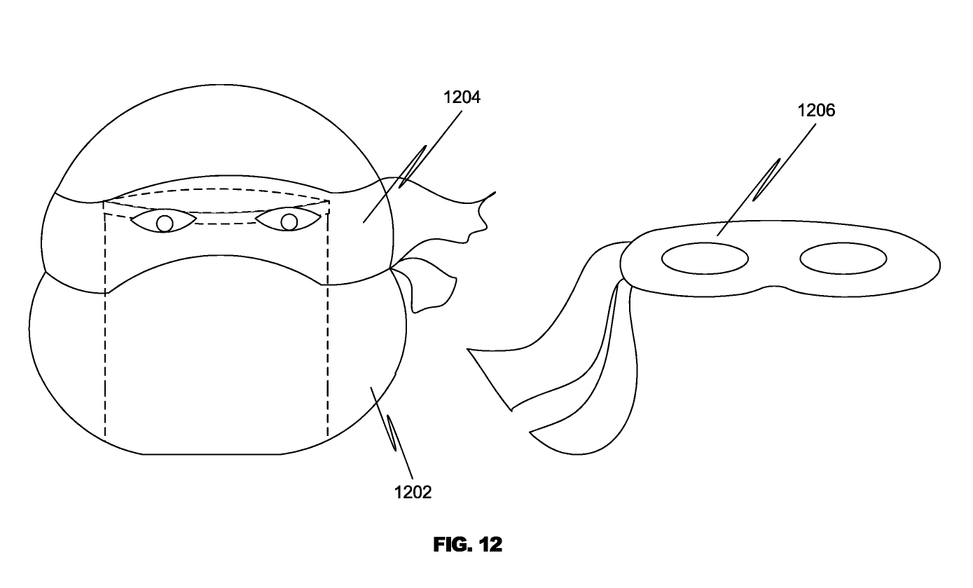

FIG. 12 shows an additional embodiment of the removable cover 1202 that may be formed to have a common base and a complementary shape to that of the part of the brake fluid reservoir with which it is held in contact with the fastening means. The removable cover 1202 may also contain a removable accessory 1204 that may be connected, removed, or replaced with a similar removable accessory to customize the aesthetic look of the removable cover 1202. The removable accessory 1204 may be connected to the removable cover 1202 by the means of Velcro, a zipper, or any other suitable fastening mechanism. This may allow additional customization options, as the base may remain common for all the overs, and the upper portion may be shaped to the likeness of the user. As shown in the figure, removable accessories (1204 and 1206) may be irremovably connected to the removable cover. The removable accessories 1024, and 1206 may have a similar physical build, and connecting mechanism to connect with the removable cover 1202, but may be different in their construction, shape, or color to add improve the visual appeal of the removable cover 1202. Alternatively, the removable accessories 1204 and 1206 may not be connected to the removable cover 1202, and may still not deplete the removable cover 1202 in terms of the function.

Although the invention has been explained in relation to its preferred embodiment, it is to be understood that many other possible modifications and variations can be made without departing from the spirit and scope of the invention.

We claim:

1. A removable cover for a brake fluid reservoir of a motorcycle, wherein the removable cover comprises a membrane configured to enclose an exterior surface of the brake fluid reservoir, wherein the membrane comprises at least one opening configured to receive the brake fluid reservoir, wherein the membrane is capable of forming a volume configured to enclose the brake fluid reservoir, wherein an external surface of the membrane is formed as a head comprising eyes, nose and ears, wherein at least a portion of the membrane possesses elasticity.

2. The removable cover of claim 1, wherein a periphery of the at least one opening comprises an elastic material.

3. The removable cover of claim 1 further comprising a side pouch configured to store an object.

4. The removable cover of claim 1 further comprising:
a flexible OLED configured to display a programmable information;
a power source configured to provide power to the flexible OLED;
a processor coupled to the flexible OLED, wherein the processor is configured to control displaying of the programmable information; and
a memory configured to store the programmable information.

5. The removable cover of claim 4 further comprising a receiver coupled to the processor, wherein the receiver is configured to receive the programmable information from an external device.

6. The removable cover of claim 1 further comprising a GPS sensor configured to determine a location of the removable cover.

7. The removable cover of claim 4, wherein at least a portion of the flexible OLED is transparent to visible light, wherein the portion of the flexible OLED is configured to reveal contents of the brake fluid reservoir.

8. The removable cover of claim 1 further comprising a camera configured to capture images.

9. The removable cover of claim 1 further comprising:
a level sensor configured to sense a level of brake fluid in the brake fluid reservoir; and
a transmitter configured to wirelessly transmit the level of brake fluid to an external device.

10. The removable cover of claim 7 further comprising a temperature sensor configured to detect a temperature associated with the brake fluid reservoir.

11. The removable cover of claim 1, wherein the at least opening comprises an opening configured to allow access to a filling orifice of the brake fluid reservoir.

12. The removable cover of claim 1 further comprising a removable accessory configured to customize an aesthetic look of the removable cover, wherein the removable cover further comprises a fastening mechanism configured to fasten the removable accessory to the removable cover.

13. A removable cover for a brake fluid reservoir of a motorcycle, wherein the removable cover comprises:
a membrane configured to enclose an exterior surface of the brake fluid reservoir, wherein the membrane comprises at least one opening configured to receive the brake fluid reservoir, wherein the membrane is capable of forming a volume configured to enclose the brake fluid reservoir, wherein an external surface of the membrane is formed as a head comprising eyes, nose and ears; and
a fastening mechanism attached to the membrane, wherein the fastening mechanism is configured to fasten the removable cover to the brake fluid reservoir.

14. A removable cover for a brake fluid reservoir of a motorcycle, wherein the removable cover comprises:
a main body comprising:
a left ear piece extending from a top left of the main body;
a right ear piece extending from a top right of the main body;
a front face protrusion extending from a lower front of the main body;
a left eyeball piece positioned above the front protrusion and proximal to the left side of the main body;
a right eyeball piece positioned above the front protrusion and proximal to the right side of the main body;
an opening positioned at a bottom center of the main body,
wherein the opening is configured to receive the brake fluid reservoir; and
an elastic band disposed along the circumference of the opening.

15. The method of claim 14, wherein the front protrusion further comprises a nosepiece positioned near a top of the front protrusion.

16. The removable cover of claim 14 further comprising an openable flap configured to be opened to reveal a filling orifice of the brake fluid reservoir, wherein the openable flap comprises a fastening mechanism configured to fasten the openable flap to the removable cover.

17. The removable cover of claim 14 further comprising a removable accessory configured to customize an aesthetic look of the removable cover, wherein the removable cover further comprises a fastening mechanism configured to fasten the removable accessory to the removable cover.

18. The removable cover of claim 14 further comprising:
a level sensor configured to sense a level of brake fluid in the brake fluid reservoir; and
a transmitter configured to wirelessly transmit the level of brake fluid to an external device.

19. The removable cover of claim 18 further comprising:
a flexible OLED configured to display a programmable information comprising the level of brake fluid;
a power source configured to provide power to the flexible OLED; and
a processor coupled to each of the flexible OLED and the level sensor,
wherein the processor is configured to control displaying of the programmable information.

20. The removable cover of claim 19, wherein at least a portion of the flexible OLED is transparent to visible light, wherein the portion of the flexible OLED is configured to reveal contents of the brake fluid reservoir.
